(19) United States
(12) Patent Application Publication
(10) Pub. No.: US 2011/0137923 A1
(43) Pub. Date: Jun. 9, 2011

(54) XBRL DATA MAPPING BUILDER

(75) Inventors: VLADIMIR KOROTEYEV, BROOKLYN, NY (US); MAKSIM KOROTEYEV, BROOKLYN, NY (US)

(73) Assignee: EVTEXT, INC., BROOKLYN, NY (US)

(21) Appl. No.: 12/634,635

(22) Filed: Dec. 9, 2009

(51) Int. Cl. G06F 17/30

(52) U.S. Cl. 707/756; 707/E17.044

(57) ABSTRACT

A method and computer program for automatic mapping of Extensible Business Reports Language (XBRL) Data to corresponding locations in an initial business document. The program takes XBRL filing, together with text of the initial report, and starts a data mapping engine based on Evolutionary Optimization. The engine searches for the most plausible locations in the document for every data item. After the data locations have been identified, the program tags them in the document and creates visualization forms so a user could easily see and verify correspondence between 2 formats of the same data: saved in XBRL filing and presented in the document.

### FIELD OF INVENTION

The present invention relates to XBRL (eXtensible Business Reporting Language) and, in particular, to an XBRL application or program.

### DESCRIPTION OF PRIOR ART

The present invention is directed to a method that applies Evolutionary Optimization algorithm to the task of automated XBRL data mapping and to a computer program that manages the following processing steps:
Loading of XBRL instance and structure XML, files and creation of in-memory objects for manipulations on data
Initialization of automatic data mapping process
Creation of visual representations for XBRL presentation and validation structures linked to the document text

The use of Evolutionary Optimization for the task of XBRL Data Mapping is the core of the invention. The search for document locations of data values presented in XBRL filings can be interpreted as a task of combinatorial optimization. Most of the values presented in XBRL Instance documents can correspond to more than one text object in the initial document. Average XBRL filing contains over a hundred data items. This makes the number of variations of mapping huge and inaccessible for the complete enumeration.

Evolutionary Data Mapping algorithm proposed in this invention allows reaching the best possible variant of data localization in several hundred steps. With the support of in-memory data caching the algorithm manages to find the required mapping solution in minutes, even at a personal computer with modest processing power.

The method starts from random mapping solution generation. According to generic Evolutionary Optimization schema, it is required to generate an initial population of random solutions. Using the XBRL and HTML Utilities we create a list of possible document locations for every XBRL data item. A Random mapping solutions generator produces complete variants of data mapping, combining random locations for every data item.

Population plays a very important role in the Evolutionary Optimization process. It maintains a restricted set of the best variants of a solution, and thus serves as a store of features that have proved their usefulness as higher than average.

After creating the initial population of random solutions, an algorithm starts the main loop of Evolutionary Optimization. At every step of the main loop the algorithm creates a new variant of mapping solution, combining locations of data items from parents, two randomly selected members of the population. Two mutually complimentary modification methods provide a transformation of the best parent solutions' features to a new offspring solution and the restoration of missed features. They are crossover and mutation.

Crossover takes two solutions and combines their features that are document locations for the same data items in our case. The whole purpose of the crossover is propagation of the promising features found at the prior steps of Evolutionary Process and saved in population. In order to enhance the productivity of crossover, we calculate and save individual estimations for every data link in the solution. The estimations allow selecting better links with higher probability. Thus, crossover presents the conservative side of optimization, saving and passing to new generations the best findings of the past trials.

Mutation does quite the opposite. It provides new solutions with minor random deviations from the mainstream of the features existing in the population. The idea behind the mutation is the following: crossover alone is capable of combining parents' features only. Thus, it would never be able to include into a new solution a link that is missed in the population. Mutation closes the gap, providing new solutions with all the variations of links existing for the corresponding data items. It uses individual link plausibility estimations for convergence optimization. The links with the worst estimations get mutated more frequently.

In order to support XBRL Data mapping, the program comprises all the classes and utility components required for input and output format conversions and in-memory processing, in addition to Evolutionary Mapping classes. Among them, specialized classes and utility methods for loading the XBRL document schema and basic taxonomy presentations and calculations structures referenced from the schema. Taxonomy structures are presented in multiple XML files saved on internet sites. The structures loading classes traverse through them, load and save the structures as a collection of in-memory objects for further use.

The program further comprises data, presentation and calculations conversion classes and utility methods for XBRL instance files. They support the creation of in-memory instance objects and structures from instance XML files and basic structures loaded, as reviewed above.

One more part of the program essential for the mapping process is HTML conversion utility. It provides the successful mapping of data items to initial document locations, it is absolutely required to be able to:
Find the position of every HTML tag and every word of text in the initial document
Save structure relations (part-of) between the parts of the initial document
Identify clusters of words corresponding to such text objects as paragraphs, tables and parts of tables: columns, rows and cells
Modify document's text, Inserting marking tags around required text element

HTML Utility supports all these actions by creation of in-memory presentation of the HTML document and providing methods for loading, manipulations and modifications.

The last part of the program to be mentioned is the Mapping Request class that plays the role of interface between the user or automatic script and the program. It allows specifying files containing all parts of the instance filing:
Schema XSD file
Instance data XML file
Instance presentation XML file
Instance calculations XML file

### BACKGROUND OF THE INVENTION

XBRL (eXtensible Business Reporting Language) has become a de facto standard for business and financial data representation (http://xbrl.org/frontend.aspx?clk=LK&val=20). It normalizes data hidden in report texts providing unified semantic tags for data items and a structure covering relations between data categories. It is hard to overestimate the importance of such standardization, as it allows the collection and fast processing of financial data from various sources.

At the same time, the step to XBRL representation doesn't come free. Text representation of financial data is more habitual for human readers and it takes a substantial effort for those making preparations to create appropriate mapping of the data to the more computer-oriented XBRL representation. The size of the XBRL structure (over 13,000 categories) and the subjective interpretation of data elements makes mapping highly tedious and imprecise.

One of the filing process problems is the lack of visibility. XBRL format doesn't save links to the data location in the initial business report document and thus the user loses the ability to verify the correctness of data extraction.

### DESCRIPTION OF DRAWINGS

FIG. 1 is a block diagram of a computer environment in which XBRL Data Mapping Builder program can be employed

FIG. 2 is a high level static UML class diagram of XBRL Data Mapping Builder program

FIG. 3 contains a high level static UMI, class diagram of Evolutionary XBRL Mapping components

FIG. 4 illustrates random mapping solution generation

FIG. 5 illustrates crossover of parent solutions during the Evolutionary XBRL Mapping process

FIG. 6 is a diagram of conversion utilities interaction

FIG. 7 illustrates process of HTML document conversion by HTML Container

FIG. 8 demonstrates a fragment of sample visualization of final XBRL Data Mapping solution

FIG. 9 illustrates interaction between XBRL Data Request, instance data files, document HTML and Evolutionary XBRL Data Mapping processor

### DESCRIPTION OF THE PREFERRED EMBODIMENT

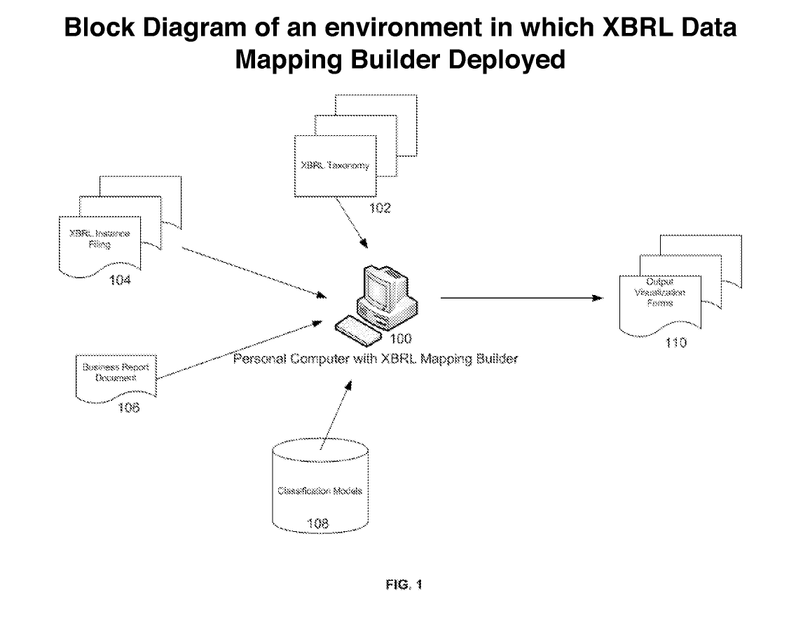

With reference to FIG. 1 a typical computer environment within which XBRL Data Mapping Builder program manages to build links between filing data and document text Is illustrated. The program is hereinafter referred to as data mapping application. The environment comprises a computer 100 comprising:
a processor
a random access memory capable of storing the mapping application and data from XBRL filing and HTML document
a hard drive capable of storing a copy of the mapping application, XBRL taxonomies, XBRL instance files, HTML document and resulting output forms as well as operating system program and data files

In the course of building a mapping solution, the mapping application first loads essential parts of XBRL Taxonomy 102 consisting of:
a set of inter-referenced XBRL schema (XSD) files
a set of XBRL presentation files
a set of XBRL calculations files

After basic Taxonomy structures had been loaded, the mapping application loads XBRL Instance files 104 and converts them into in-memory structures. The instance files include:
an XBRL schema file (XSD)
an XBRL presentation file
an XBRL calculations file
an instance data XML file

The next data source required for building a mapping solution is HTML document file 106. The mapping application loads the HTML document and converts it into an in-memory structure. It saves links between the parts of in-memory structure and the HTML document for further use at output forms generation time.

Statistical models 108 help to better identify the most plausible locations of data items. The models contain statistical relations between text objects built on review of multiple precedents of XBRL data locations. The mapping application loads statistical models for every data item category, including end terms and abstract text objects.

After processing the mapping application converts the resulting solution into output forms 110. Depending on the input parameters, output forms can be created as a set of linked HTML files or a combination of HTML and Microsoft Excel files

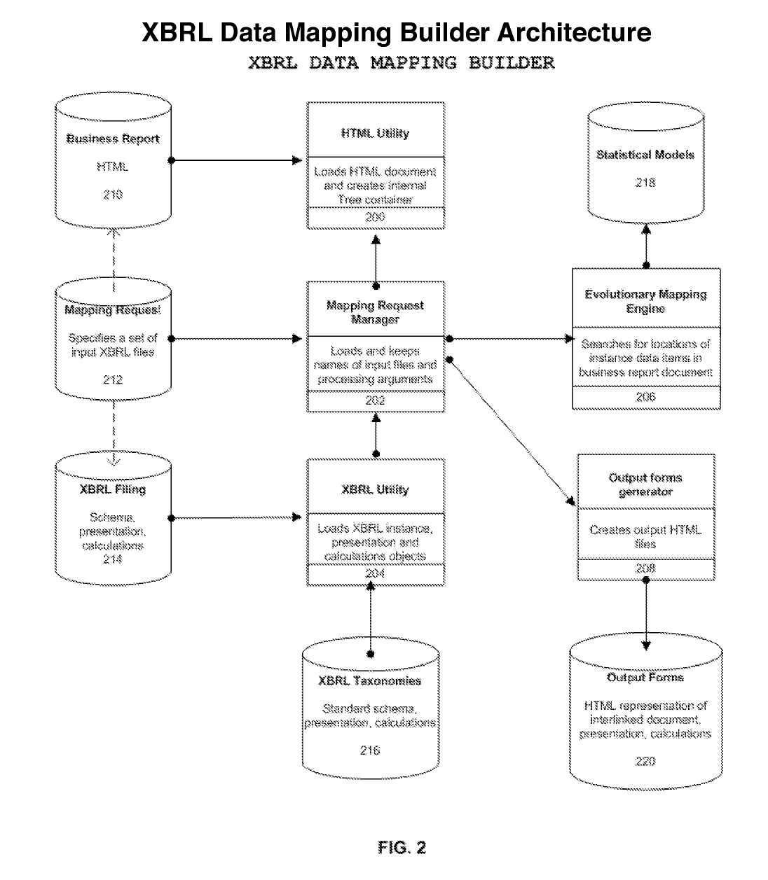

With reference to FIG. 2 the mapping application is further comprised of an HTML Utility 200 that provides the user with the ability to import a business report 210 in HTML format and convert it into in-memory structure for text object separation and identification.

Additionally, the XBRL Utility 204 provides the ability to import XBRL taxonomy 216 and instance XBRL files 214. The utility is able to browse through multiple inter-linked schema, presentations and calculations files, load the required ones, and convert them into in-memory objects.

Mapping Request Manager 202 controls processing of other parts of the data mapping application by loading names of XBRL Instance and HTML document files.

Consequently, the Mapping Request Manager checks the availability and correctness of all specified data files, and in successful cases starts the Evolutionary Mapping Engine 206. The Evolutionary Mapping Engine, in its turn, imports statistical Text Mining models and performs the Evolutionary Mapping Algorithm in a separate thread.

After the optimal mapping has been built, the Output forms generator 208 creates output forms 220 as a set of interlinked HTML files for source business document, presentation and calculations.

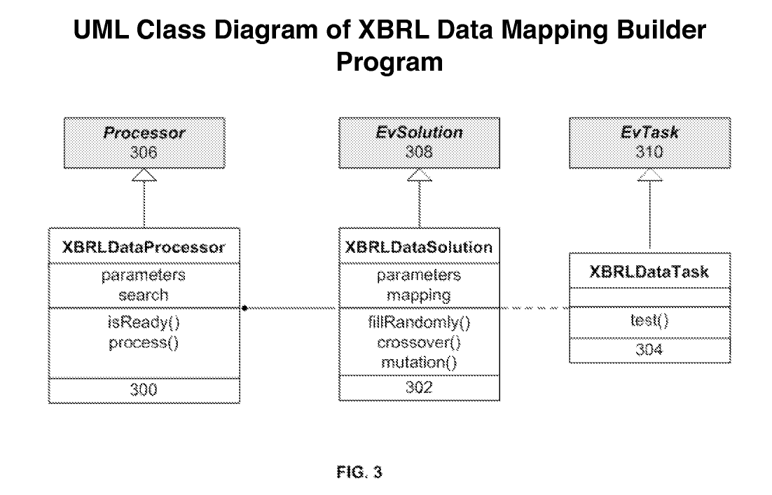

With reference to FIG. 3 the classes comprising the Evolutionary XBRL Mapping Engine. The engine represents an implementation of the Evolutionary Search algorithm (http://www.ev-soft.com). Evolutionary Software, Inc. provides a library of Java classes that includes generic classes that need to be specialized for a particular optimization task. Class XBRLDataProcessor 300 implements generic interface Processor 306 that serves as a controller for the Evolutionary Optimization process. An instance of XBRLDataProcess performs the following actions:
initializes all the objects required for successful optimization
connects active and controlling elements using events exchange mechanism
provides a client application with the ability to check out the readiness of the processor to start optimization process
starts optimization session
returns the best solution found during the optimization session

Next class XBRLDataSolution 302 extends generic abstract class EvSolution 308. Each instance of this class contains a complete variant of the mapping of instance data items to locations in the document text. In the course of optimization, Evolutionary Search generates several thousand of such variants. The first several hundred of them serve as a source of random features that should be generated as uniformly as possible. XBRLDataSolution generates random variants at the initial stage of search in the method fillRandompy( ). Further convergence of the search to the best variant depends on the way variants of the solution selected to population are used for the creation of new solutions. XBRLDataSolution combines features of a couple of selected population members in method crossover( ). One more method requiring implementation is mutation( ). It updates variants created by crossover( ), supplying them with random deviations.

One more class that requires implementation for the given optimization problem is EvTask 310. It is meant for the calculation of optimization criteria. XBRLDataTask 304 implements the estimation of data mapping variant. Composed estimation criteria for the mapping data optimization combines the following partial estimations:
consistency of co-location of the data items associated with the same statement inside the same HTML Table
consistency of co-location of the data items associated with the same statement and context inside the same HTML Table column
consistency of co-location of the data items with the same name and different contexts inside the same HTML Table row
Number of data items with missed locations
Number of locations linked to more than one data item
Results of statistical classification models estimations for individual data as well as for financial statement tables as wholes

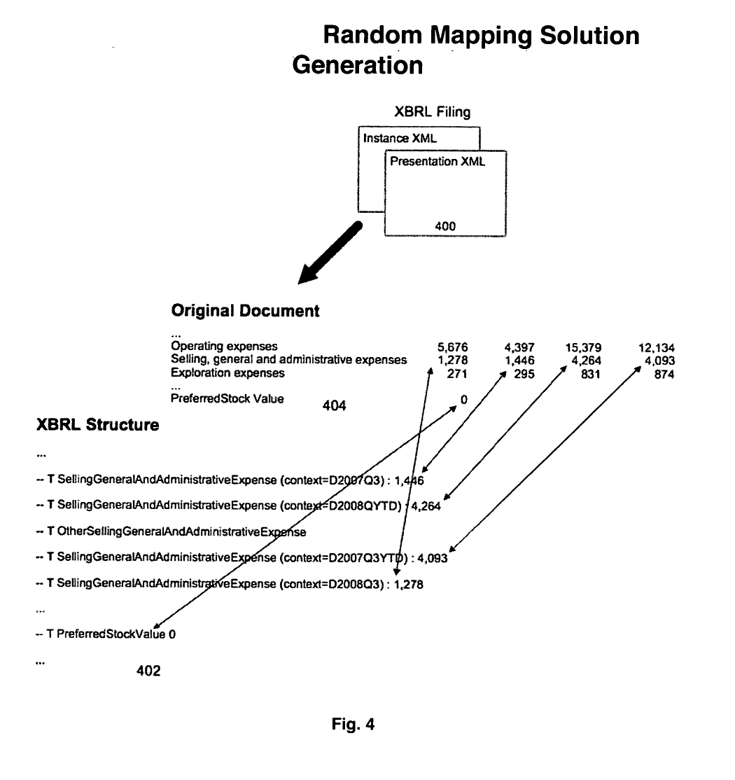

With reference to FIG. 4 a general schema of random data mapping is comprised of a set on XBRL Instance files 400 containing data records, presentation and calculations structures. Each data item contains a value that can be linked to a number of locations in the initial document, as shown in schema by links between a fragment of presentation structure 402 and a fragment of the initial document 404. generation of random mapping solutions implemented in method XBRLDataSolution.fillRandomly( ) takes one link per data item, using a random number generator with a uniform distribution function.

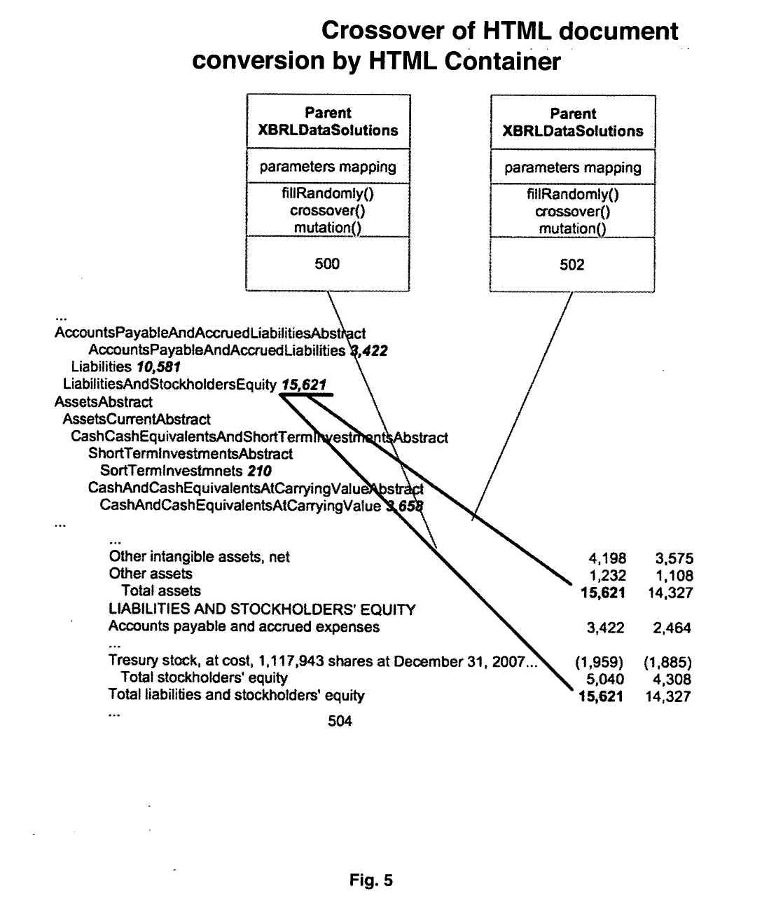

With reference to FIG. 5 an illustration of crossover of two parent XDRLDataSolution 500 and 502 containing different mapping links for the same data item “LiabilitiesNdStckholdersEquity” demonstrates the links in a fragment of visualization 504. The Crossover algorithm compares individual estimations of both links and selects one of them for incorporation into the offspring solution. The probability that a link is selected for inclusion into an offspring is proportional to its individual estimation.

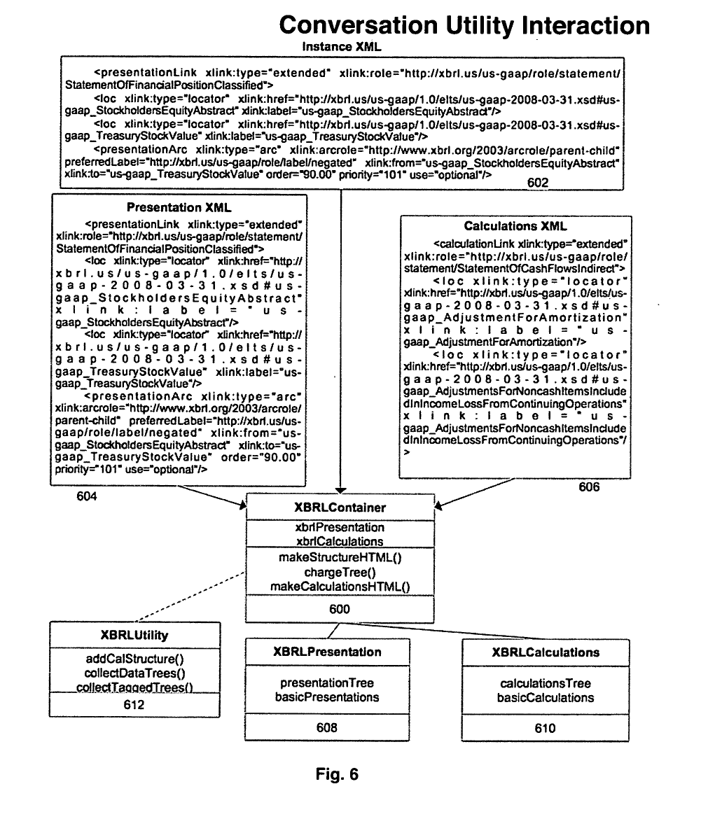

With reference to FIG. 6 a diagram of interactions between data conversion utilities and data sources is comprised of a core data class XBRLContainer 600 that holds data arrays and structures imported from instance files: a Presentation XML 604, Calculations XML 606 and Instance XML 602. XBRLPresentation 608 specializes in the conversion of presentation XMLs into in-memory presentation objects. Another utility class XBRLCalculations 610 loads calculations XMLs and converts them into in-memory calculations objects.

XBRLUtility 612 provides a set of utility methods used by other conversion utilities.

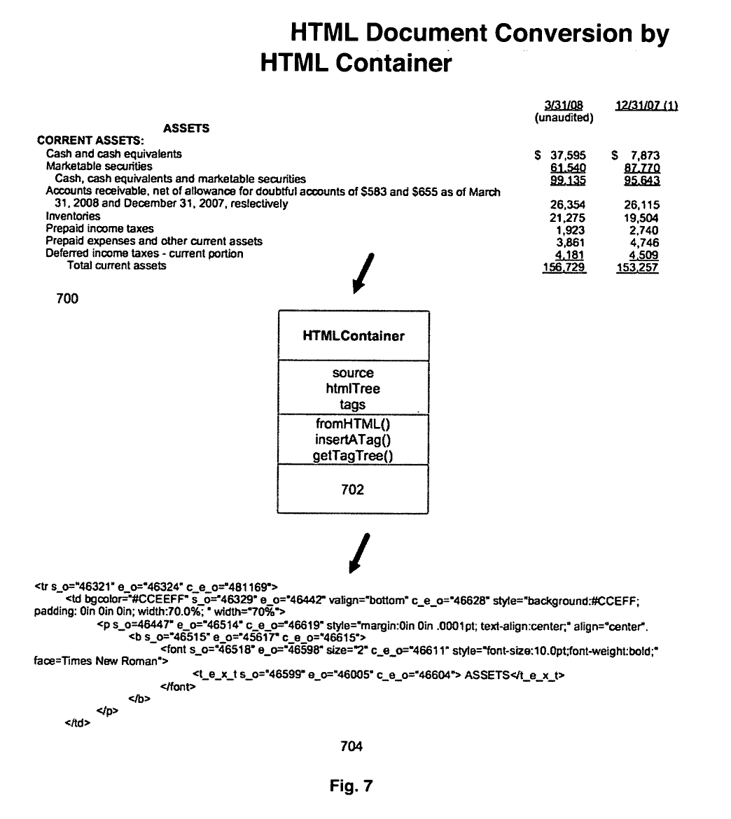

With reference to FIG. 7 illustration of the process of HTML document conversion by the HTML Container consists of a fragment of initial HTML file 700 and a utility class 702 that loads the document and converts it into an internal tree-like object, 704 which contains all HTML tags as branches and saves the coordinates of each tag's location in the initial document.

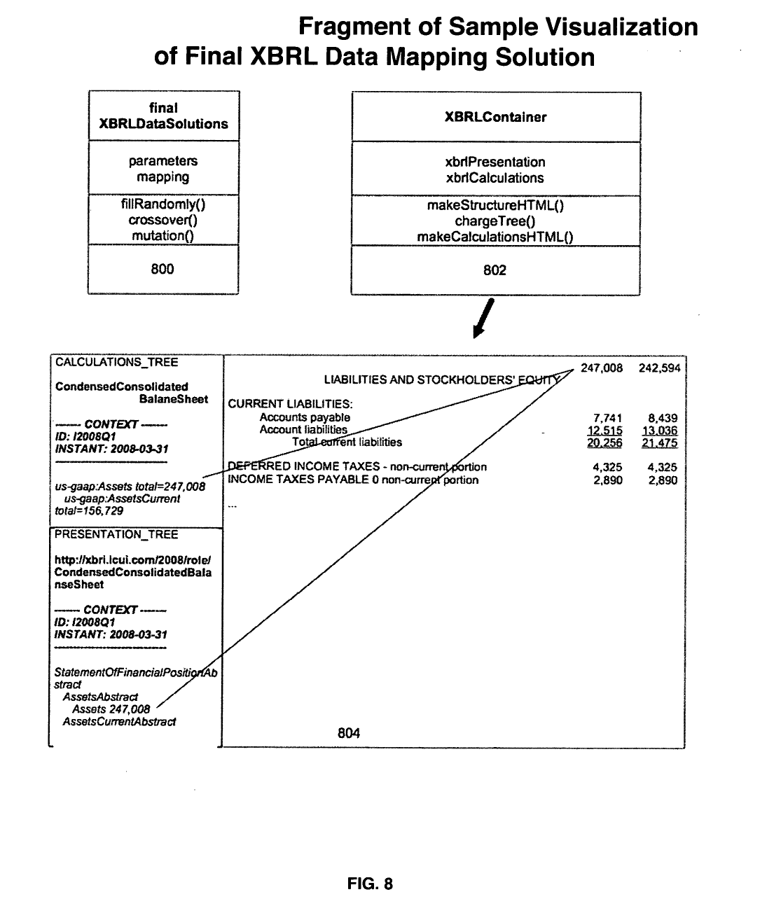

With reference to FIG. 8 a fragment of sample visualization of final XBRL Data Mapping solution contains the final XBRL Data Solution 800 found by the Evolutionary Mapping algorithm taken by a utility class XBRLContainer 802. The utility inserts reference tags around the data items locations into the initial HTML documents and generates separate HTMLs for presentation and calculations structures. The fourth frame HTML combines these three resulting HTMLs in joined view 804. HTML links inserted into in the generated HTMLs provides a user with the ability to move from one HTML panel to another by simple mouse clicks on the data representations.

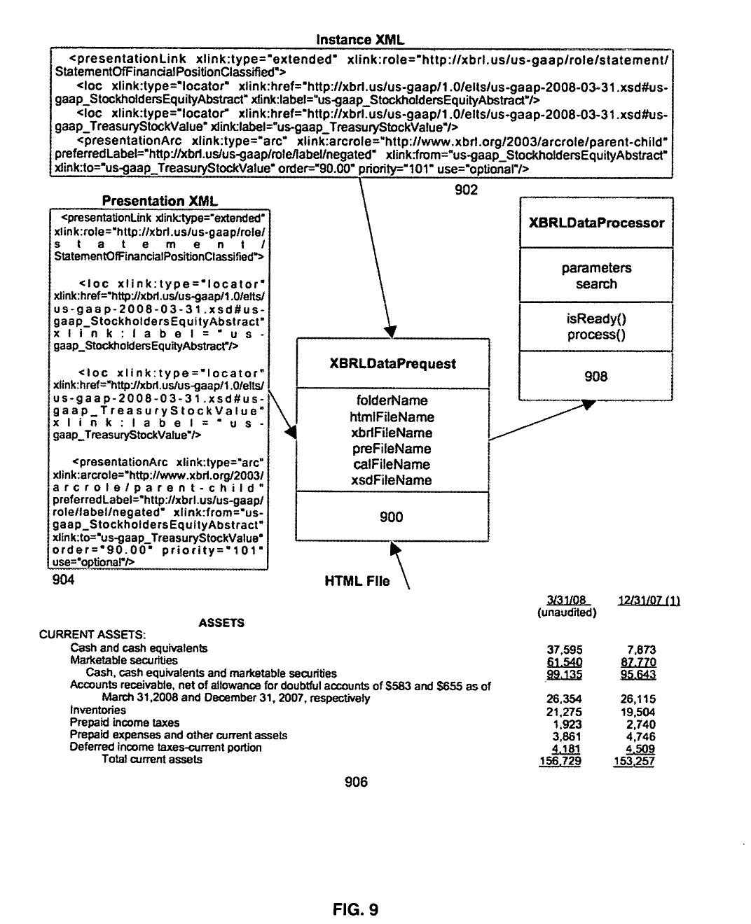

With reference to FIG. 9 instance data file 902, presentation file 904 and document HTML 906 get loaded and converted under supervision of XBRL Data Request 900. Then, the request manager passes all the created in-memory objects to the Evolutionary XBRL Data Mapping Processor 908 which builds optimal mapping from them.

What is claimed is:

2. A method for automatic XBRL data mapping based on Evolutionary Optimization comprising:
an implementation of random mapping solution generator;
an algorithm for crossover of parent mapping solutions;
an algorithm for task oriented mutation of mapping solution;
an implementation of optimization criteria accounting statistical relations between the data items in business reports as well as duplications of locations and missed data items.

3. A computer program that is accessible through a web interface, allowing a remote user to perform and visualize the mapping of data contained in XBRL filing to locations in the business document text comprising:
a mapping engine implementing the method for Evolutionary XBRL data mapping as claimed in claim 1;
a library of Java classes supporting the processing of XBRL Taxonomy formats as well as instance XBRL files;
a utility for loading and processing data and structure relations between data items contained in standard XBRL files;
a utility for loading and processing XBRL validation relations presented in calculations files;
a utility for converting and processing business documents presented in HTML (Hyper Text Markup Language) format, saving links to the positions of text objects in the initial document;
a utility for creating output HTML files, containing linked representation of data structure, calculations validations structures and tagged business report document;
a data mapping request manager that allows a user to specify a set of XBRL instance files and a report document file to be linked

4. The method, according to claim 1, wherein implementation of random mapping solution generator, builds a set of allowable locations for every data item, based on the normalization of numeric values to significant nonzero digits

5. The method, according to claim 1, wherein algorithm for crossover of parent mapping solutions takes a couple of randomly picked parents from a population of selected mapping solutions and forms a new solution, copying in it locations of the parent's data locations. If the parents have different locations for the same data item crossover, the algorithm picks one of them based on probability distribution derived from the individual estimations of each variant in the parents' solutions

6. The method, according to claim 1, wherein the algorithm for task oriented mutation makes random mapping for a limited set of data items using probabilities distribution derived from pre-calculated individual estimations of locations inherited at the crossover step

7. The method, according to claim 1, wherein the implementation of optimization criteria uses multi-part estimation comprising:
Co-location of the data items associated with the same statement inside the same HTML Table
Co-location of the data items associated with the same statement and context inside the same HTML Table column
Co-location of the data items with the same name and different contexts inside the same HTML Table row
Number of data items with missed locations
Number of locations linked to more than one data item
Results of statistical classification models estimations for individual data as well as for financial statement tables as wholes

8. A computer program, as claimed in claim 2, wherein:
said mapping engine applying Evolutionary process to the task of data-text linkage optimization, performing several thousand steps, using a complete variant of mapping as a genotype, estimating every variant of solution with composite optimization criteria as claimed in claim 6, creating initial population with random mapping as claimed in claim 3, performing the rest of the steps using the crossover of randomly selected population members as claimed in claim 4, and mutating the new solution with mutation algorithm as claimed in claim 5.

9. A computer program, as claimed in claim 2, wherein:
said utility for loading and processing data and structure relations is capable of generating internal XBRL presentation structures from given schema (XSD) and presentation XML files

10. A computer program, as claimed in claim 2, wherein:
said library of Java classes capable of locating and downloading interlinked common XBRL Taxonomy schema, presentation and calculation files

11. A computer program, as claimed in claim 2, wherein:
said utility for loading and processing XBRL validation for an instance XBRL filing providing the capability for forming calculations structures, estimating calculations errors for particular variant of mapping and creating output calculations representation

12. A computer program, as claimed in claim 2, wherein:
said utility for converting and processing business documents presented in HTML (Hyper Text Markup Language) format that creates internal Tree container, providing direct access to tagged parts of the HTML code and holding links to the initial document supporting this parallel update in internal and initial representations

13. A computer program, as claimed in claim 2, wherein:
said utility for creating output HTML files for visualization of XBRL presentation and calculation structures linked to an updated business document, providing a capability to explore both way structures-text connections using any standard internet browser

14. A computer program, as claimed in claim 2, wherein:
said data mapping request manager providing the capability of specifying a set of input XBRL files and processing parameters.
